(19) United States
(12) Patent Application Publication
(10) Pub. No.: US 2017/0291670 A1
(43) Pub. Date: Oct. 12, 2017

(54) AUTONOMOUS WORKBOATS AND METHODS OF USING SAME

(71) Applicant: Texas Marine & Offshore Projects LLC, Boston, MA (US)

(72) Inventor: Michael Gordon Johnson, Dallas, TX (US)

(73) Assignee: Texas Marine & Offshore Projects LLC, Boston, MA (US)

(21) Appl. No.: 15/094,948

(22) Filed: Apr. 8, 2016

(51) Int. Cl. B63G 8/00; G05D 1/00; B63B 35/00

(52) U.S. Cl. CPC B63G 8/001; B63B 35/00; G05D 1/0027; B63B 2035/008; B63G 2008/004

(57) ABSTRACT

A sea-surface vessel configured to operate in an autonomous mode and to implement autonomous operation of one or more undersea autonomous vehicles is described herein. The sea-surface vehicle comprising a first control system on board the sea-surface vessel for implementing autonomous control of the sea-surface vessel, wherein the autonomous mode of operation includes a remotely controlled mode of operation of the sea-surface vessel, a first communications system for sending data and receiving data between an autonomous undersea vehicle and the sea surface vessel, a second control system for controlling the autonomous undersea vehicle by using information transmitted from the first communications system, the information including a command for activation of at least one pre-programmed maneuver for the autonomous undersea vehicle, a navigation system on board the sea-surface vessel for locating the sea-surface vessel and for providing the location information to the first control system, a thrust system for controlling sea-surface vessel speed and direction according to control instructions from the first control system and a second communications system on board the sea-surface vessel for exchanging information with a remote management system, wherein the remote management system sends information for activating at least one autonomous pre-programmed maneuver of the sea-surface vehicle and the remote management system receives information from the sea-surface vessel, including data from the undersea vehicle.

### TECHNICAL FIELD

The present invention relates to an unmanned boat which operates autonomously or by remote control and to methods of using such boats in industries that work on and in the oceans, coastal and inland waters, rivers, and commercial ports.

### BACKGROUND

Remote controlled boats have been considered for fishing and for use in surveying underwater and water bottom conditions of seas, lakes, ponds and rivers. Unmanned boats have also been considered for military uses such as locating mines in water, security, surveillance, and protection of capital ships.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 shows an autonomous workboat according to one embodiment.

FIG. 2 shows a side profile view of a workboat equipped with a control pollution boom on a top deck that can be deployed for pollution control operations in accordance with embodiments described herein.

FIG. 3A shows an autonomous unmanned workboat in plan and profile views in accordance with embodiments described herein.

FIG. 3B shows a mother ship, two autonomous workboats and a plurality of undersea autonomous vessels in accordance with embodiments described herein.

FIGS. 4A and 4B show a gang of autonomous workboats performing a coordinated pollution control tasks in accordance with one embodiment.

FIG. 5A show workboats deploying from an offshore supply boat in the vicinity of an offshore oil production platform in accordance with embodiments described herein.

FIG. 5B shows autonomous unmanned boats or vessels capable of deploying and/or towing in-water survey equipment in accordance with embodiments described herein.

FIG. 5C shows autonomous unmanned delivering and holding barge on station in accordance with embodiments described herein.

FIG. 5D shows an acoustic transmitter that is deployed by a workboat for undersea communications with vessels or assets in accordance with embodiments described herein.

FIG. 5E shows an embodiment of an autonomous workboat performing the deployment of an unmanned remote operated vehicle (ROV) in accordance with embodiments described herein.

FIG. 6 shows a block diagram of various components of a mother ship, a workboat and an autonomous undersea vessel in accordance with one embodiment.

FIG. 7 is a block diagram of an exemplary method for autonomous vessel operation in accordance with one embodiment.

FIG. 8 is a block diagram of an exemplary computer system for implementing autonomous vessel operation in accordance with one embodiment.

The figures are provided in order to provide a thorough understanding of the present invention. The figures should not be construed as limiting the breath of the invention in any manner.

### DETAILED DESCRIPTION

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the invention as defined by the appended claims. Furthermore, in the Detailed Description, numerous specific details are set forth in order to provide a thorough understanding of embodiments of the present subject matter. However, embodiments may be practiced without these specific details. In other instances, well known methods, procedures, and components have not been described in detail as not to unnecessarily obscure aspects of the described embodiments.

The autonomous workboats described herein may operate in offshore and/or inshore waters and/or the high-seas. The boats may work in autonomous collaborative operations employing multiple workboats. Embodiments described herein provide a system and methods for collaborating with undersea vessels with an autonomous sea-surface boat.

In one embodiment, an autonomous unmanned workboat capable of operating as an individual unit or as a collaborative gang of multiple units that work together to execute a multi-unit task, wherein when working as a gang, a central control unit manages the collaboration of the gang, integrating the vessel operational controls, vessel navigation systems, transit and rules of the road, interaction resolution systems, and multi-unit gang interactive controls.

In one embodiment, the boats may be refueled remotely. In one embodiment, the boats have dimensions or are sized to dimensions allowing them to be shipped or transported via truck or ship capable of shipping or transporting a high-top 20 foot shipping container.

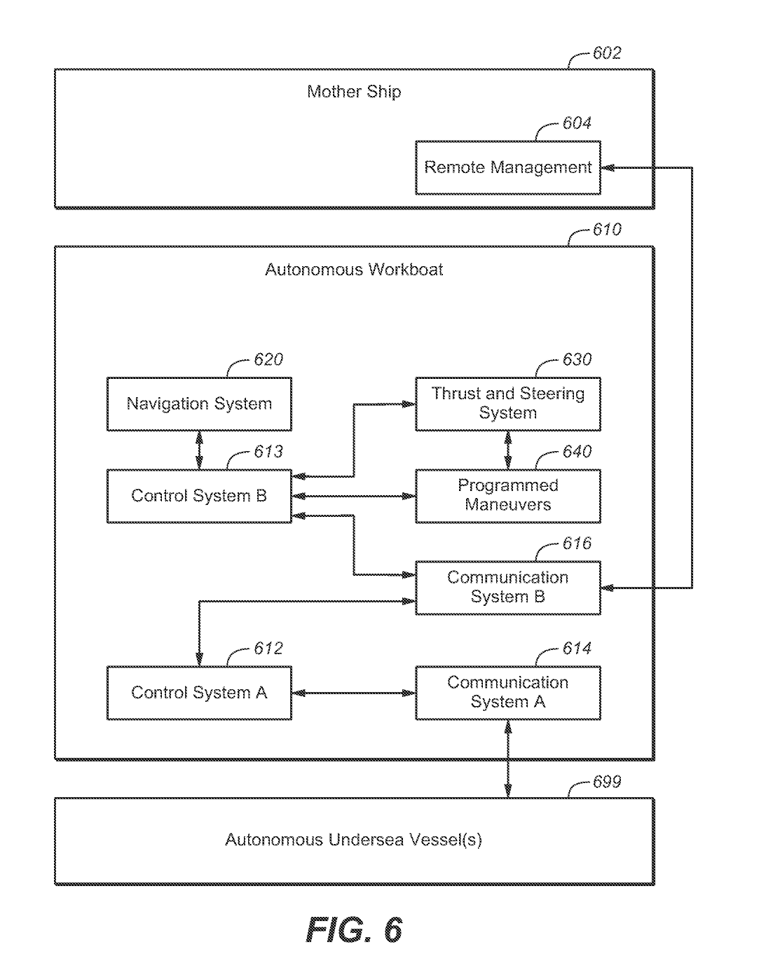

Embodiments described herein include an autonomous unmanned workboat capable of perceiving other vessels and surface objects near to it of a determined distance and size using RADAR, vessel AIS systems, USBL, laser vision, and infra-red cameras and beacons. These components are shown as navigation systems 620 and control systems 613 and 612 of FIG. 6.

In one embodiment, the autonomous sea surface vehicle described herein uses a survey grade global positioning system (shown as navigation systems 620) and may have a Class B AIS transponder, a digital or analog radar system, Infrared or other electro-optic camera, VHF radio, cellular modem, iridium satellite communication, industrial 802.11x wireless transponder, maritime broadband transceiver, acoustic modem, optical communication or any other positioning, navigation and/or communication system in accordance with embodiments described herein.

Embodiments described herein enable the autonomous vessel described herein to run extended survey operations without loss of navigational accuracy. The autonomous vessel described herein works in collaboration with one or more autonomous undersea vehicles, following and providing over watch of the undersea vehicles during a mission or series of maneuvers. This unmanned operation frees up mother ship activity to position additional autonomous undersea vehicles or tend to other tasks, such as launching and recovering sea assets. The autonomous undersea vessel described herein is configured to collect (autonomous undersea vessel) AUV data using acoustic or optical communication, for example. This data can then be stored at the autonomous sea surface vehicle or can be sent in real-time to a mother ship.

In one embodiment, the autonomous sea-surface vehicle described herein comprises a propulsion system that may include one or more electric thrusters and an electric generator. In one embodiment, the autonomous sea surface vehicle described herein has a continuous duty cycle between 15 and 25 days, dependent on sea conditions and level of utilization. In one embodiment, the autonomous sea surface vehicle described herein is configured to operate in Sea State 7 and is self-righting. In one embodiment, the autonomous sea surface vehicle described herein may use a gasoline or diesel powered electric generator to generate propulsion energy. A solar electricity generation system is also provided in one embodiment.

The autonomous workboats described herein are well suited to control one or more undersea vessel, such as a remote operated vessel (ROV) without direct human control. The undersea vessels may be used to perform undersea operations such as pipeline inspections, undersea equipment inspections, leak detection, valve operations, wiring operations, cable placement, part assembly, seafloor mapping, environmental monitoring, material handling, well monitoring, etc. The undersea vessel may also be used to collect data from one or more sensors that are remote or local to the undersea vessel.

In one embodiment, the un-manned workboat or vessel of the present invention can be operated with both autonomous and remote control systems or a combination of the two called supervised autonomous. The vessel is task-driven and is capable of servicing multiple industries that work on and in the oceans, coastal & inland waters, rivers, and commercial ports. To simplify mobilization, the workboat or vessel of one embodiment is sized to the exterior dimensions of a high-top twenty-foot shipping container. The communication, navigation, and systems mast is self-erecting in one embodiment and will fold down for shipping over land in one embodiment.

In one embodiment, the sea surface vessel communicates with undersea assets to receive information, send information or to manipulate or control an undersea asset. For example, an undersea asset could be a pipeline sensor, a valve, a communications transmission line, a manifold, or any other installed or placed undersea object.

In one embodiment, the undersea vessel is preprogrammed to perform one or more operations. In this embodiment, the undersea vessel is configured to receive position information from the sea surface vessel to assist the undersea vessel to perform one or more pre-programmed maneuvers. In one embodiment, the sea surface vessel provides operational instructions to the undersea vessel that may override a pre-programmed operation that the undersea vessel is performing.

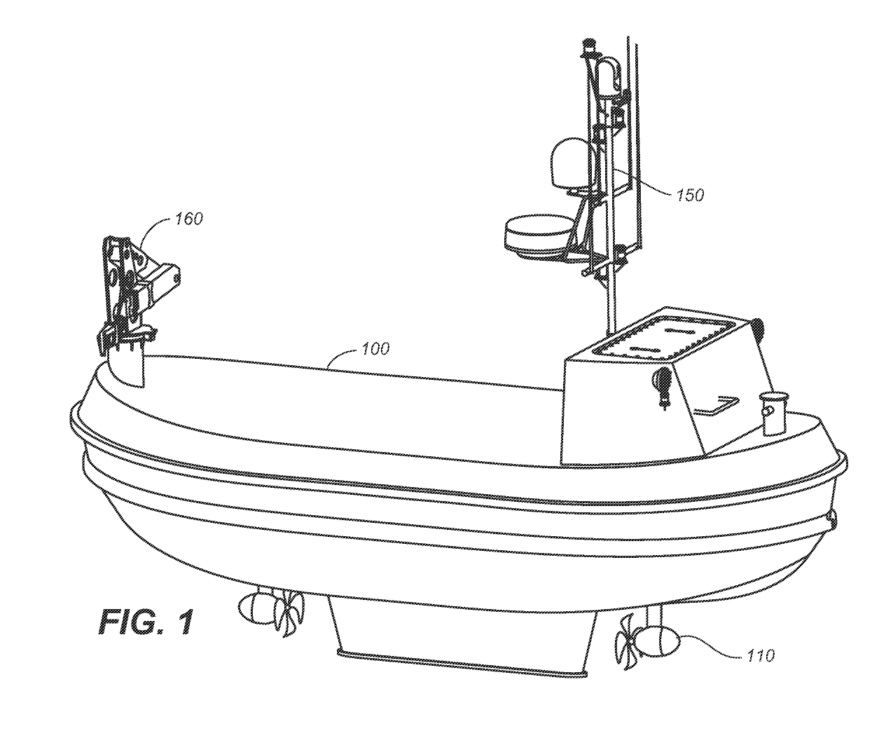

FIG. 1 shows an autonomous workboat 100 according to one embodiment. In one embodiment, the vessel 100 is powered by a hybrid-diesel engine generator system and is propelled by two electrically-driven 360-degree azimuthing propellers 110. Through the hybrid-electrical control system, the propulsion motors can take power directly from the generators or from an electrical storage bank of lithium-ion batteries. The generators or solar systems recharge the batteries as required.

In one embodiment, the workboat has a semi-displacement hull that provides open-ocean stability for surveying or ultra-short baseline (USBL) communications and a powerful propulsion system.

In one embodiment, the workboat includes a pilot house and helm and can be manually-driven as a conventional boat or autonomously driven.

In one embodiment, the boats have a top-side work deck capable of being outfitted with various equipment packages to suit multiple specific jobs. A remote-controlled manipulator arm 160 is mounted to the deck to assist equipment deployment and general on-water operations.

In one embodiment, the propulsion control systems of the boats include a power management system, thruster control system, dynamic positioning system that utilizes inputs from Satellite GPS, RTKGPS, COTS Radar, AIS, infra-red camera, and magnetic compass, one or more are mounted on mast 150. The boats are also controlled using a custom designed autonomous controls system which acts as an overall umbrella control systems with proprietary algorithms that control general operations, navigation, collision avoidance, and specific tasks of the workboat and/or one or more undersea autonomous vessel.

The autonomous control system working together with the dynamic positioning system will make the boats capable of autonomous and remote controlled operations that are based on pre-programmed workflows. For example, in one embodiment, the workboat described herein is well suited to perform autonomous navigation between multiple on-water locations, autonomous navigation and tracking along a programmed track, path, or grid, autonomous station-keeping including near-to other vessels or structures.

The workboat described herein is also well suited to perform autonomous towing, tugging, or pushing of in-water barges, boats, equipment, structures, or oil pollution boom individually or collaboratively with other autonomous unmanned boats.

The workboat described herein is also well suited to perform autonomous navigation and working together with a manned-vessel while maintaining a position relative to the manned vessel to enable the ability to jointly control a device or equipment together between the boats.

The workboat described herein is also well suited to perform autonomous navigation and working collaboratively with multiple autonomous unmanned boats while towing and/or with the boats connected together to deploy oil booms in continuous patterns that contain potential pollution around an in-water area or structure such as an offshore oil & gas drilling or production facility or deployed as a barrier to protect an area from in-water pollution.

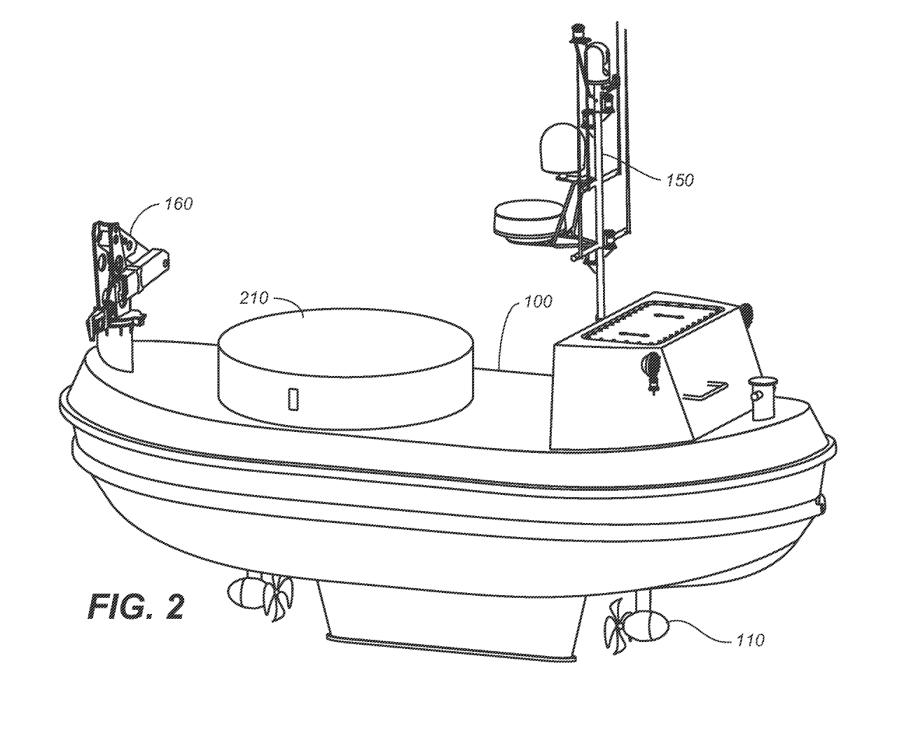

FIG. 2 shows a side profile view of a workboat 100 equipped with a control pollution boom 210 on a top deck that can be deployed for pollution control operations.

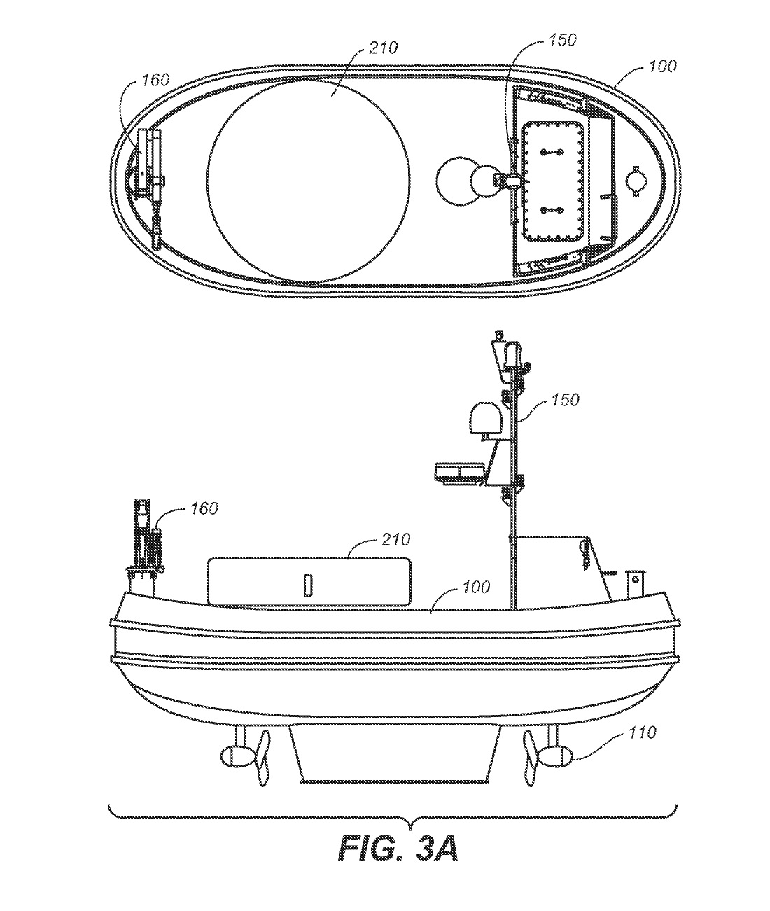

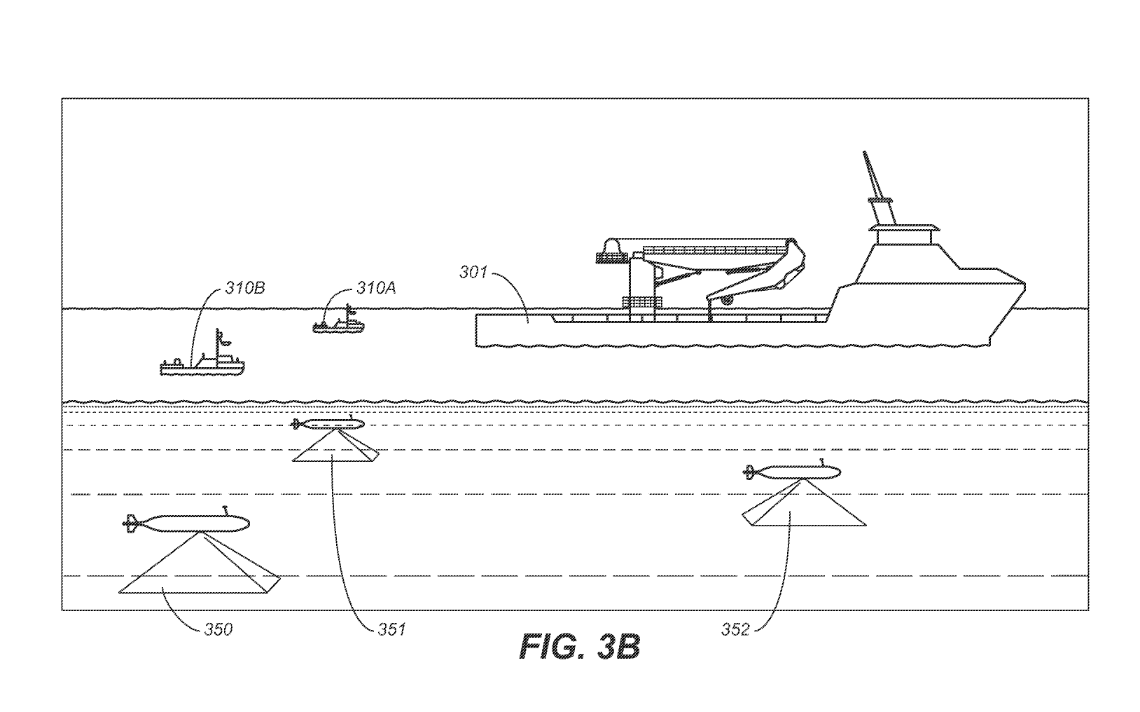

FIG. 3A shows an autonomous unmanned workboat in plan and profile views in accordance with one embodiment. In the plan view, workboat 100 includes a crane or manipulation arm 160, pollution control materials 210 and mast 150 that may have various navigational and communication system installed thereon. In one embodiment, the mast is capable of folding down to be parallel with the deck of the workboat when not in use.

In the profile view, one or more propulsion systems 110 can be seen as well as the various components that can be mounted to mast 150. The pollution control items 210 can include a spool of oil collecting boom material that can be deployed or retrieved using a winch, for example.

FIG. 3B shows a mother ship 301, two autonomous workboats 310A and 310B and a plurality of undersea autonomous vessels 350, 351 and 352. In one embodiment, each workboat (310A and 310B can control one or more undersea autonomous vessel. In the arrangement shown in FIG. 3B, the mother ship 301 controls undersea vessel 352 while workboat 310A controls undersea vessel 351 and workboat 310B controls undersea vessel 350.

### Remote Task Execution

As noted above, in one embodiment, the boat is sized to the limiting dimensions of a TEU (Twenty foot Equivalent Unit shipping container) and therefore is easily shipped and deployable to most areas of the world. In one embodiment, the boat is or maybe outfitted with lifting lugs for simplified loading and deployment.

Each boat or vessel is capable of operating as an individual unit or as a collaborative gang of multiple units that work together to execute a multi-unit task. In one embodiment, when working as a gang, the collaborative operations will be managed by a central control unit that is located at or near-to the work site and overseen by a human technician. In one embodiment, an algorithmic collaborative control system integrates the vessel operational controls, vessel navigation systems, transit and rules of the road, interaction resolution systems, and multi-unit gang interactive controls.

### Operational Services

The workboats or vessels of the present invention have many uses. In one embodiment, the boats provide first-mover operational services such as, for non-limiting example, surface pollution operations.

In one embodiment of a method of the present invention, autonomous unmanned workboats or vessels are deployed to install a continuous floating pollution boom barrier around in-water project sites, oil and gas exploration and extraction sites, platform installations, decommissioning projects and marine casualty sites. For example, in FIG. 2, the workboat is provisioned with a pollution control boom 210.

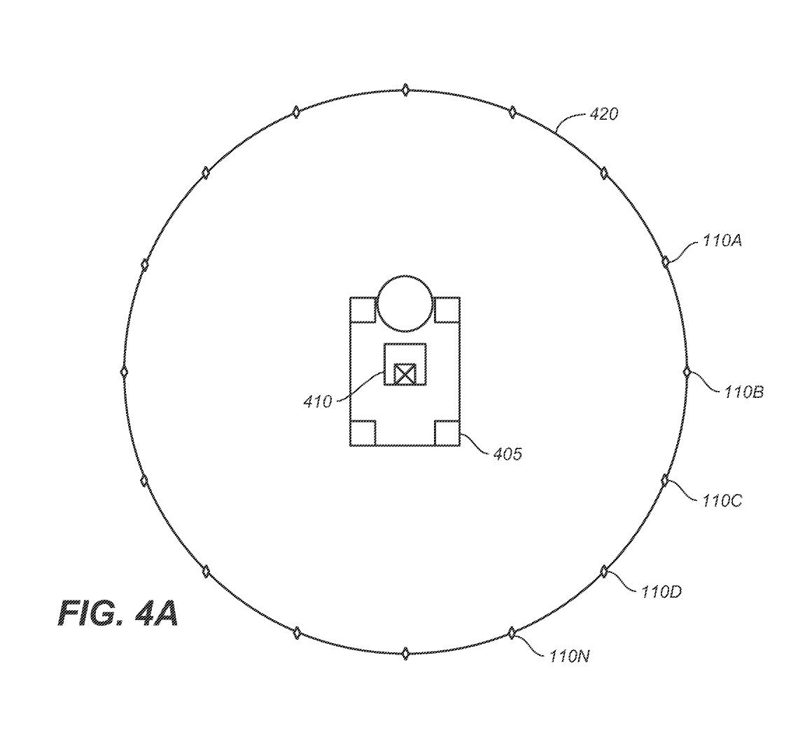

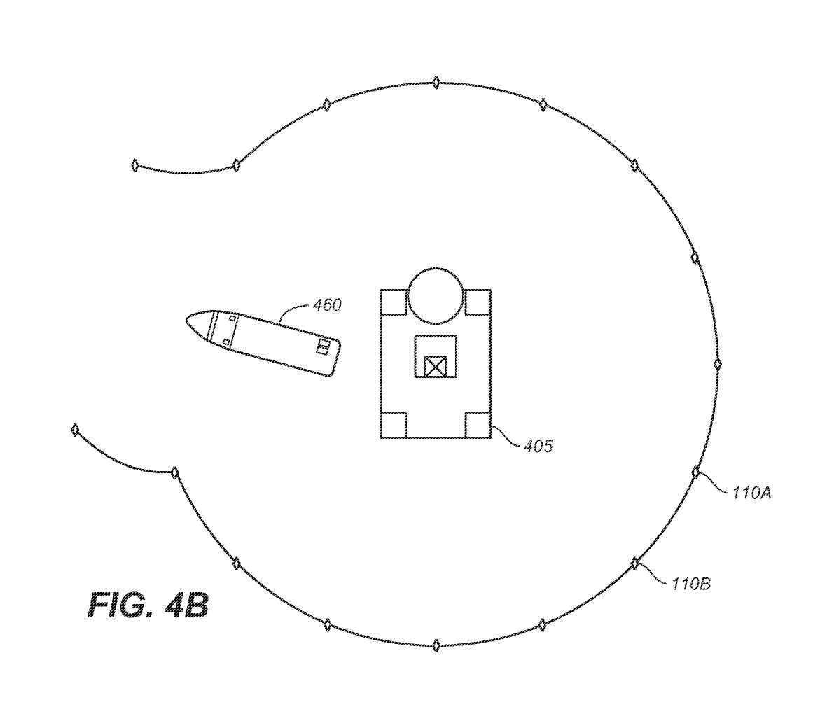

In this embodiment, the workboats or vessels can be outfitted with a spool of floating containment boom 210, and through remote and autonomous operation the workboats/vessels collaborate, interconnect and deploy the boom sections to create a continuous containment enclosure around the work site. The workboats/vessels may keep station so that the boom enclosure maintains the specified perimeter, while also having the capability of opening the enclosure to allow vessels to pass through the barrier zone, as shown in FIGS. 4A and 4B.

### Towing of Oil Pollution Boom

In one embodiment of a method of the invention, autonomous unmanned workboats or vessels work individually or collaboratively with multiple boats (110A-110N) to tow sections of floating oil-pollution booms 420 to gather and collect surface water pollution, oil spills and slicks, and/or debris that may come from an oil platform 405. In one embodiment, an RTK base station 410 is located on the oil platform 405 and can be used to assist in the positioning of workboats 110A-110N.

In one example embodiment of the present invention, multiple autonomous unmanned workboats of the invention work together collaboratively as a “gang” to provide a continuous first-order pollution blockade to ensure that any surface pollution incident is contained within a 360 degree barrier.

In one embodiment, each workboat is outfitted with floating spill boom on a powered internal reel. In one embodiment, the spill boom is around 200′ long and has a diameter of around 24 inches. The workboats are capable of being manually connected or of automatically linking together via boom and then holding station in a blockade perimeter.

The workboat will open the blockade to accommodate site operations of an offshore service vessel (OSV) 460 as illustrated in FIG. 4B.

While the workboats are controlled through autonomous algorithmic systems with pre-programmed work flows, each gang deployment could also be managed through a user interface by a control technician that will be based on the drill rig 405 or other platform or vessel near to the work site.

In one embodiment, a refueling tanker workboat will support the gang of workboats and autonomously refuel each boat though a stab boom and hose system.

In one embodiment, the workboats will operate in conditions up to the limit of effectiveness of the pollution boom. When the conditions exceed or are forecast to exceed this limit, the workboats will disengage and retract the booms or be manually disconnected and move away from the platform in a weather hold pattern.

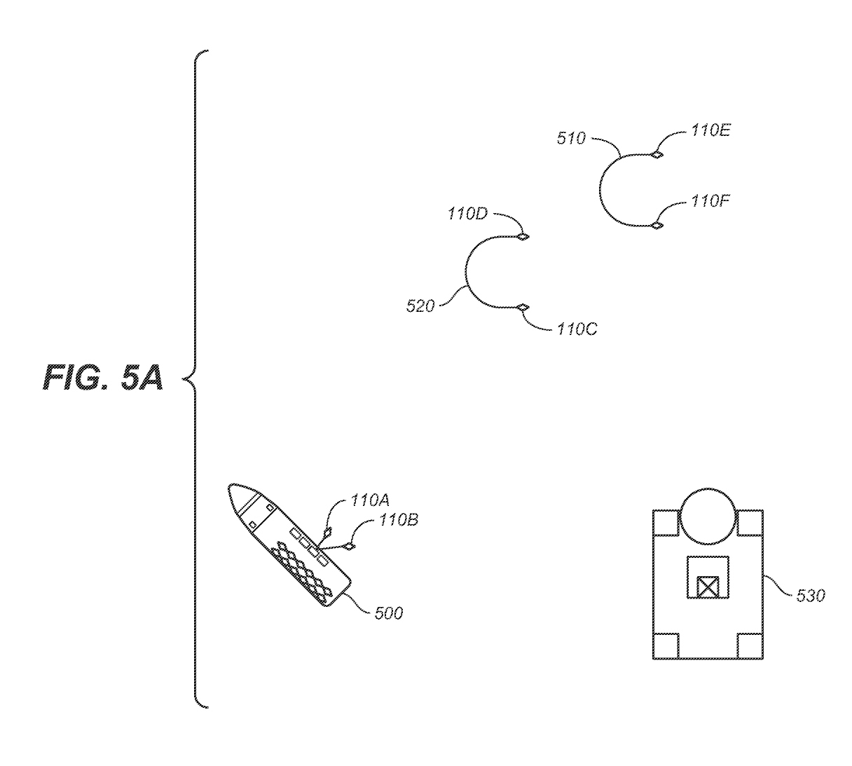

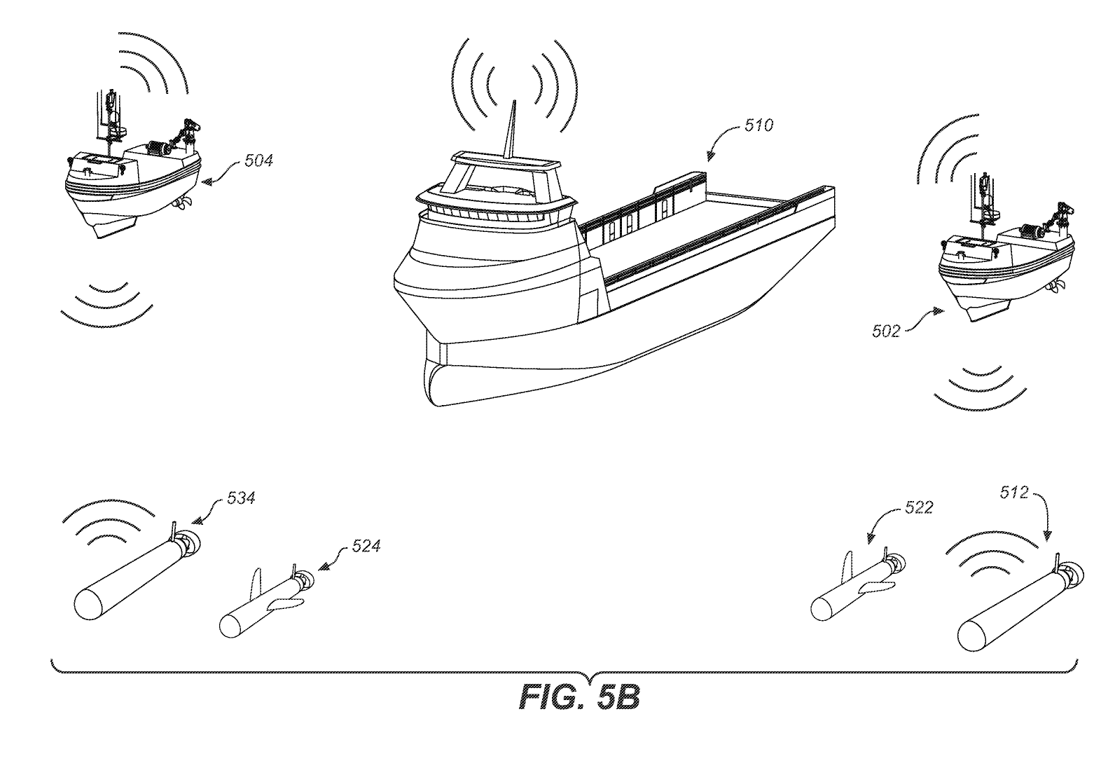

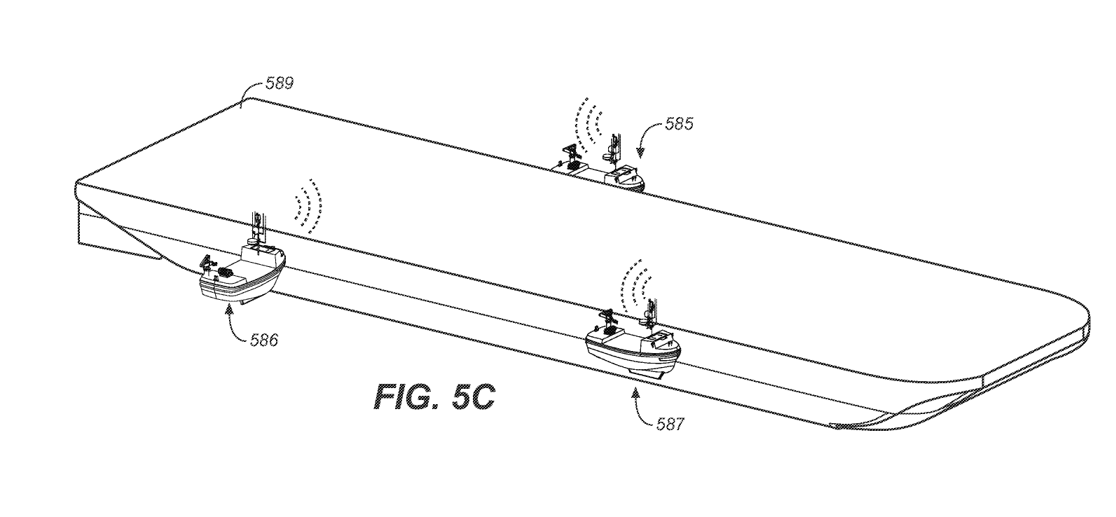

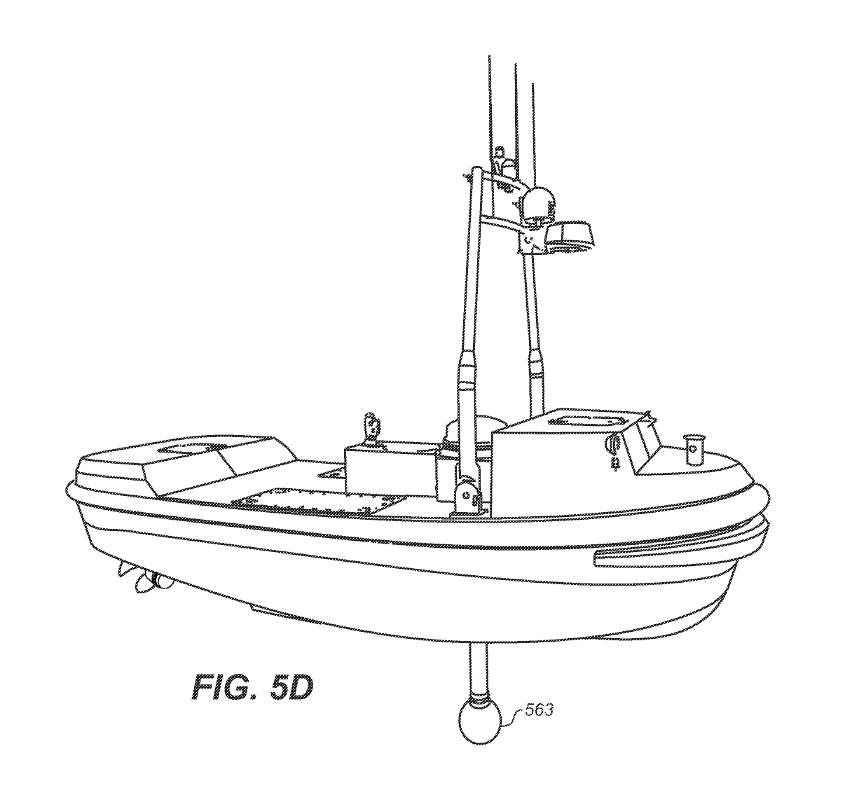

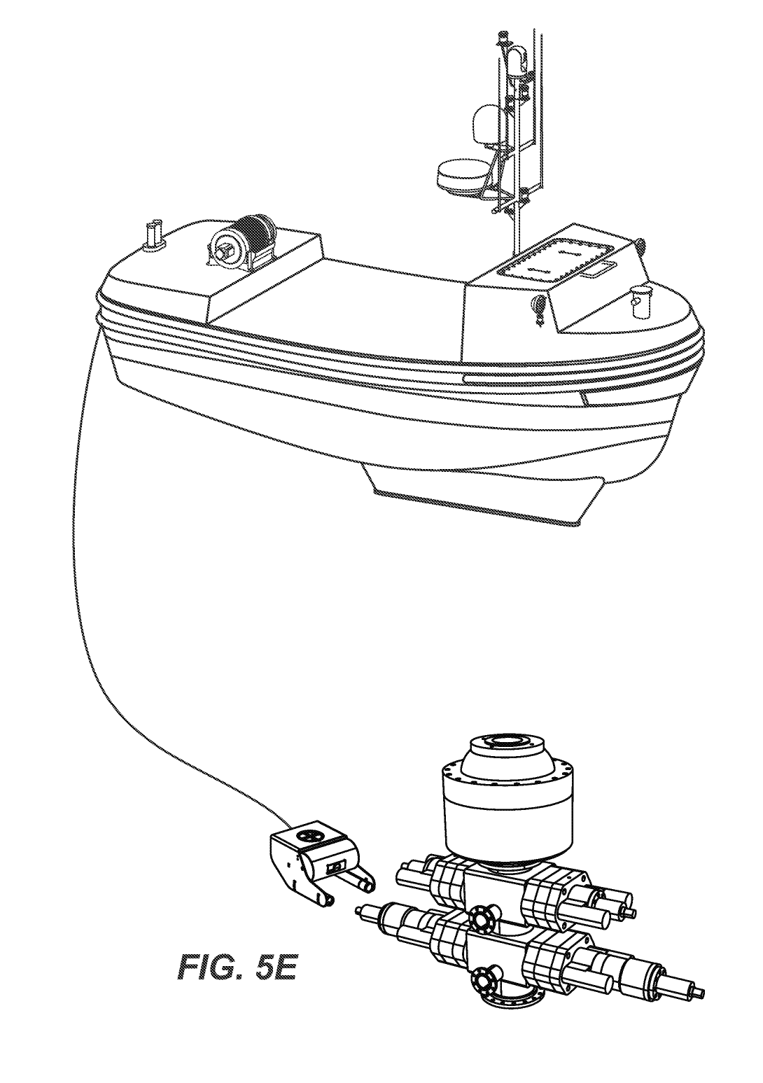

The autonomous work boats can be used to tow floating pollution boom to collect surface oil of other pollutants. FIG. 5A show workboats 110A-110F deploying from an offshore supply boat 500 in the vicinity of an offshore oil production platform 530. The work boats then work collaboratively to collect surface pollution by towing lanes 510 and 520 through the polluted area around an oil platform 530.

### Air Drop Emergency Response to Remote Incidents Involving Vessels or Personnel in Distress

In one embodiment of a method of the invention, autonomous unmanned boats or vessels are air-dropped from a military-style cargo aircraft such as a C-17 or C-130. The boats are released out the rear door of the aircraft while in flight and parachuted near a vessel in distress on the high-seas. Once in the water, the boats autonomously power-up and motor towards the distressed vessel or personnel. If the incident requires emergency towing, then one or more autonomous unmanned boats with towing equipment will be deployed. If it's a response to remote pollution, then autonomous unmanned boats with pollution booms will be deployed.

### Survey Towing

FIG. 5B shows autonomous unmanned boats or vessels capable of deploying and/or towing in-water survey equipment such as multi-beam sonar or sub-bottom profiling. The autonomous unmanned boats 502 and 504 or vessels navigate on a pre-designed path or grid 599 using GPS. Autonomous unmanned boats or vessels working collaboratively, each towing or controlling un-tethered survey gear and can create a broad array and therefore can obtain a large swath of data. Using the onboard GPS navigation and laser fan-beam positioning, the boats maintain a set distance and location relative to each other. The boats store the data and/or broadcast the collected data in real time to a selected station. In another embodiment, the autonomous workboats control one or more undersea vehicles. For example, in FIG. 5B, workboat 504 controls the operation of undersea vessels 534 and 524 while workboat 502 controls the operation of undersea vehicles 512 and 522 while mother ship 510 controls the workboats 504 and 502.

### Project Support—Barge & Vessel Station Keeping & Shifting

In one embodiment, autonomous unmanned boats or vessels are used to provide support to offshore construction, installation, or decommissioning projects which often utilize multiple vessels and barges to transport and prepare structures, equipment, or consumables. FIG. 5C shows autonomous unmanned boats 585, 586 and 587 delivering and holding barge 589 on station until the site team is ready to use the barge. The autonomous unmanned boats then shift the barge into or out of position as needed by the offshore site team.

### Provisional Buoys

In one embodiment of a method of the invention, autonomous unmanned boats or vessels are mobilized to a location to act as a provisional marker buoy to indicate the presence of anything that needs to be marked for awareness for other water-surface traffic, such as for non-limiting example, marking a new wreck, a disabled vessel, the perimeter of a temporary exclusion zone, an underwater obstruction or natural bar. An autonomous unmanned boat or vessel might also be used as a replacement for a buoy that has become disabled.

### Communication Relays—Surface to Subsea

In one embodiment of a method of the invention, autonomous unmanned boats or vessels are deployed to act as a communications relay between surface radio or satellite communications and subsea acoustic communications to support submerged manned-operations or submerged equipment such as subsea oil and gas equipment, sea-floor research equipment, or manned submarine communications. For Example, FIG. 5D shows an acoustic transmitter 563 that is deployed by a workboat for undersea communications with vessels or assets.

### Dredging

In one embodiment of a method of the invention, autonomous unmanned boats or vessels are used to support suction dredging programs. The boats are outfitted with deck mounted dredge pumps with suction hoses deployed via a deck winch to the controlled depth. The boats also have an acoustic depth finder and the ability to deploy single or multi-beam sonar to provide dredge depth feedback. The boats operate on a pre-designed dredge path or grid, where the boats are arranged collaboratively so that one boat performs the suction dredging and a second boat can control the outlet end of the dredge spoils discharge hose.

### Reconnaissance & Remote Intelligence—Visual

In one embodiment of a method of the invention, autonomous unmanned boats or vessels are deployed to conduct remote visual and radar reconnaissance of offshore areas or inland water ways and ports.

### Dynamic Offshore Radar Stations

In the war on drug trafficking along the offshore coasts of nation-states some countries have resorted to installing radar towers along their coasts to watch for drug transport speed boats. In one embodiment of a method of the invention, autonomous unmanned boats or vessels are deployed to an offshore area to provide remote radar reconnaissance and relay the data back to shore. The boats can propel to track the target or close in to provide visual images. The boats can also listen below water for drug transport submarines.

Tender Boat Working in Conjunction with Manned Vessel

In one embodiment of the invention, autonomous unmanned boats or vessels of the invention are working near and in conjunction with a manned vessel to control or tow an in water structure, device, or type of equipment. In one embodiment, the workboat described herein enables the deployment and operation of a fishing seine where one or multiple autonomous or remote controlled boats tows or controls the opposing end of the seine relative to the manned vessel and is capable of maintaining a pre-programmed or commanded distance from the manned vessel and/or maintains a set or variable tension on the towed device and is capable of transiting and maintaining speeds relative the manned vessel or as commanded.

### Emergency Response, Fire Fighting

In one embodiment of a method of the invention, autonomous unmanned workboats or vessels are outfitted with water pumps and/or fire-fighting monitors and used to respond to fires on ships, rigs, production platforms, or other structures on the ocean, seas, rivers, or lakes. In such method, the workboats or vessels work individually or as a collaborative pod. In one embodiment, each workboat or vessel is outfitted with an infra-red camera so that the boat is capable of identifying the hottest areas and of making closer approaches than manned-vessels. The workboats may further be outfitted with top side radiant heat-shielding for performing very close interventions to extreme heat zones, such as below an offshore platform, for example, so as to provide fire water directly to the heat up-flow zone of a burning open well head. In one embodiment, the workboats described herein are configured for collaborating to extinguish a fire on an offshore oil rig.

FIG. 5E shows an embodiment of an autonomous workboat performing the deployment of an unmanned remote operated vehicle (ROV). In this embodiment, the autonomous vessel is capable of offloading an ROV from the deck, placing the ROV into the water, deploying the ROV and safely re-loading the ROV back to the deck of the autonomous workboat. In one embodiment, more than one autonomous workboat works collaboratively to deploy and ROV.

### Open Source Platform

In one embodiment of the invention, autonomous unmanned boats or vessels of the invention are outfitted as multi-use workboats that are plug and play ready to be configured to suit the specific needs of a customer. Such boats preferably have over 100 square feet of open deck space, reserve power for added deck machinery, a full suite of communications & control equipment, and one or more deck manipulator arms.

In one embodiment, the autonomous vessel described herein is configured to actively position an autonomous undersea vehicle through continuous Ultra Short Base Line (USBL) updates. USBL is an underwater positioning system that uses a vessel mounted transceiver to detect the range and bearing to a target using acoustic signals. USBL operates by knowing a time taken for an acoustic signal to travel between a target and a transceiver and the speed at which the signal travelled (e.g., speed of sound).

A bearing can be determined by knowing a discreet difference in phase between receptions of the signal at the multiple transducers present in the transceiver. This allows the USBL system to determine a time-phase difference for each transducer and therefore calculate the angle of the arriving signal.

One embodiment includes an autonomous unmanned workboat capable of operating and decision-making using pre-programmed work flow algorithms.

One embodiment includes an autonomous unmanned workboat capable of operating with self-control using pre-programmed work flow algorithms that allow the workboat to make real-time operational decisions considering it's predetermined set of tasks, perception of vessels and other surface objects near to or in the workboat's operational area, while considering international vessel traffic rules of the road (COLREGS) and collision avoidance.

One embodiment includes an autonomous unmanned workboat with a sized design to fit within the exterior boundaries of a twenty foot international high-top shipping container for simplicity of transport and deployment to most areas of the world.

One embodiment includes a method for refueling boats while operating, the method comprising: employing a workboat that is capable of operating as a refueling tanker and that comprises a lance and hose system; wherein the unmanned workboat approaches the boat to be refueled or receiving boat with the motion and positioning of the unmanned workboat guided by an onboard perception systems and pre-programmed autonomous control workflow and the lance stabs into a locking socket on the receiving boat; moving the unmanned workboat away from the receiving boat while paying out fuel hose, wherein the fuel is pumped to the receiving boat in a determined volume and then completed; evacuating the fuel hose with a vented suction system; having the receiving boat release the lock on the lance after the refueling; and having the unmanned boat retrieve the hose and lance. One embodiment includes an autonomous unmanned workboat fitted with a hose and lance for use in refueling boats.

FIG. 6 shows a block diagram of various components of a mother ship 602, a workboat 610 and an autonomous undersea vessel 699 in accordance with one embodiment. In one embodiment, the workboat is configured to operate in an autonomous mode and to implement autonomous operation of one or more autonomous undersea vehicles 699.

The workboat includes in one embodiment, a first control system 612 on board said sea-surface vessel for implementing autonomous control of said sea-surface vessel 610, wherein the autonomous mode of operation includes a remotely controlled mode of operation of the sea-surface vessel. The workboat also has a first communications system 614 for sending data and receiving data between the autonomous undersea vessel 699 and the sea surface vessel 610. The workboat 610 also has a second control system 612 for controlling the autonomous undersea vessel 699 by using information transmitted from the first communications system 614, the information may include a command for activation of at least one pre-programmed maneuver 640 for the autonomous undersea vessel.

The workboat has a navigation system 620 for locating the sea-surface vessel 610 and providing the location information to the first control system 613. The workboat also has a thrust system 630 for controlling sea-surface vessel speed and direction according to control instructions from the first control system 612 and a second communications system 616 for exchanging information with a remote management system 604, wherein the remote management system 604 receives information from the sea-surface vessel, including data from the autonomous undersea vessel 699. The remote management system 604 may be a land based system in one embodiment.

In one embodiment, the second control systems 612 and 613 are located on board the sea-surface vessel, but in another embodiment, one or more control system is remote to the workboat.

In one embodiment, the autonomous undersea vessel 699 collects data from at least one sensor and sends the data to the sea-surface vessel 610 via the first communications system 614.

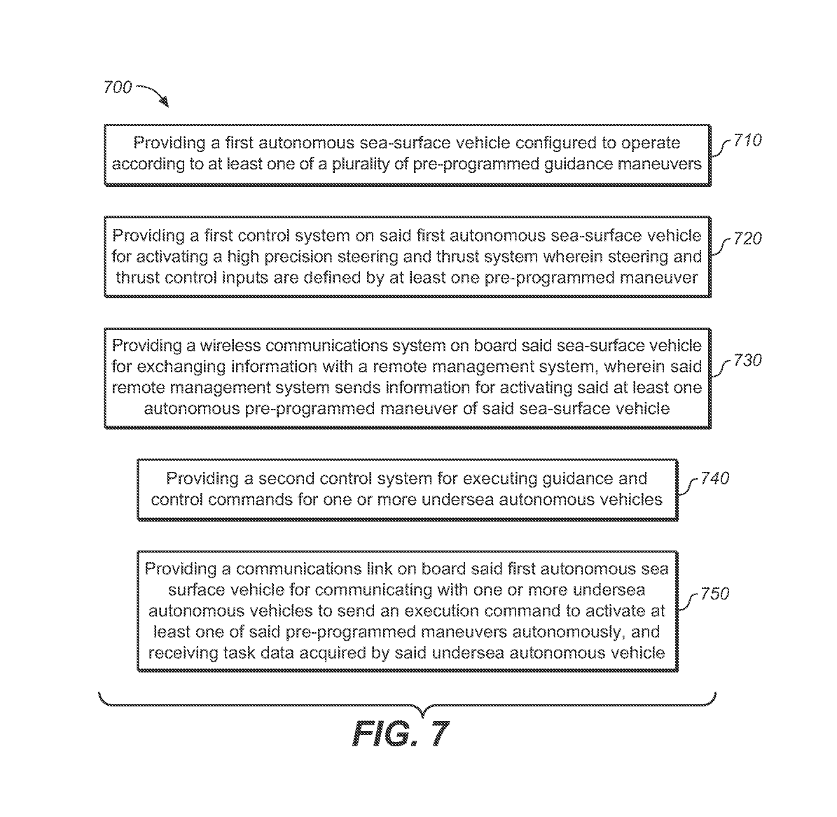

FIG. 7 is a block diagram of an exemplary method 700 for autonomous vessel operation in accordance with one embodiment. The method includes at 710 providing a first autonomous sea-surface vehicle configured to operate according to at least one of a plurality of pre-programmed guidance maneuvers.

At 720, method 700 includes providing a first control system on the first autonomous sea-surface vehicle for activating a high precision steering and thrust system wherein steering and thrust control inputs are defined by at least one pre-programmed maneuver. At 730, method 700 includes providing a wireless communications system on board the sea-surface vehicle for exchanging information with a remote management system, wherein the remote management system sends information for activating the at least one autonomous pre-programmed maneuver of the sea-surface vehicle.

At 740, method 700 includes providing a second control system for executing guidance and control commands for one or more undersea autonomous vehicles At 750 method 700 includes providing a communications link on board the first autonomous sea surface vehicle for communicating with one or more undersea autonomous vehicles to send an execution command to activate at least one of the pre-programmed maneuvers autonomously, and receiving task data acquired by the undersea autonomous vehicle.

### Example Computer System

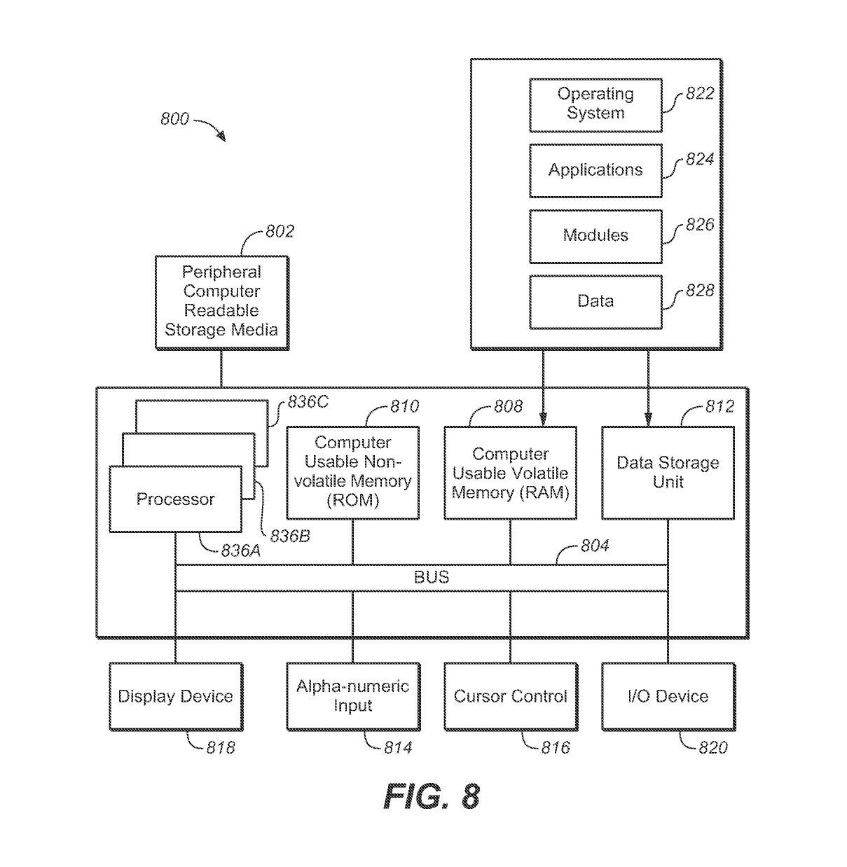

With reference now to FIG. 8, all or portions of some embodiments described herein are composed of computer-readable and computer-executable instructions that reside, for example, in computer-usable/computer-readable storage media of a computer system. That is, FIG. 8 illustrates one example of a type of computer (computer system 800) that can be used in accordance with or to implement various embodiments which are discussed herein. It is appreciated that computer system 800 of FIG. 8 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, distributed computer systems, media centers, handheld computer systems, multi-media devices, and the like. Computer system 800 of FIG. 8 is well adapted to having peripheral non-transitory computer-readable storage media 802 such as, for example, a floppy disk, a compact disc, digital versatile disc, other disc based storage, universal serial bus “thumb” drive, removable memory card, and the like coupled thereto.

System 800 of FIG. 8 includes an address/data bus 804 for communicating information, and a processor 806A coupled with bus 804 for processing information and instructions. As depicted in FIG. 8, system 800 is also well suited to a multi-processor environment in which a plurality of processors 806A, 806B, and 806C are present. Conversely, system 800 is also well suited to having a single processor such as, for example, processor 806A. Processors 806A, 806B, and 806C may be any of various types of microprocessors. System 800 also includes data storage features such as a computer usable volatile memory 808, e.g., random access memory (RAM), coupled with bus 804 for storing information and instructions for processors 806A, 806B, and 806C.

System 800 also includes computer usable non-volatile memory 810, e.g., read only memory (ROM), coupled with bus 804 for storing static information and instructions for processors 806A, 806B, and 806C. Also present in system 800 is a data storage unit 812 (e.g., a magnetic or optical disk and disk drive) coupled with bus 804 for storing information and instructions. System 800 also includes an optional alphanumeric input device 814 including alphanumeric and function keys coupled with bus 804 for communicating information and command selections to processor 806A or processors 806A, 806B, and 806C. System 800 also includes an optional cursor control device 816 coupled with bus 804 for communicating user input information and command selections to processor 806A or processors 806A, 806B, and 806C. In one embodiment, system 800 also includes an optional display device 818 coupled with bus 804 for displaying information.

Referring still to FIG. 8, optional display device 818 of FIG. 8 may be a liquid crystal device, plasma display device or other display device suitable for creating graphic images and alphanumeric characters recognizable to a user. Optional cursor control device 816 allows the computer user to dynamically signal the movement of a visible symbol (cursor) on a display screen of display device 818 and indicate user selections of selectable items displayed on display device 818. Many implementations of cursor control device 816 are known in the art including a trackball, mouse, touch pad, joystick or special keys on alphanumeric input device 814 capable of signaling movement of a given direction or manner of displacement. Alternatively, it will be appreciated that a cursor can be directed and/or activated via input from alphanumeric input device 814 using special keys and key sequence commands. System 800 is also well suited to having a cursor directed by other means such as, for example, voice commands. System 800 also includes an I/O device 820 for coupling system 800 with external entities. For example, in one embodiment, I/O device 820 is a modem for enabling wired or wireless communications between system 800 and an external network such as, but not limited to, the Internet, undersea assets, autonomous vessels, mother ships, land based stations, remote operation centers, etc.

Referring still to FIG. 8, various other components are depicted for system 800. Specifically, when present, an operating system 822, applications 824, modules 826, and data 828 are shown as typically residing in one or some combination of computer usable volatile memory 808 (e.g., RAM), computer usable non-volatile memory 810 (e.g., ROM), and data storage unit 812. In some embodiments, all or portions of various embodiments described herein are stored, for example, as an application 824 and/or module 826 in memory locations within RAM 808, computer-readable storage media within data storage unit 812, peripheral computer-readable storage media 802, and/or other tangible computer-readable storage media.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A sea-surface vessel configured to operate in an autonomous mode and to implement autonomous operation of one or more autonomous undersea vehicles, said sea surface vessel comprising:
a first control system on board said sea-surface vessel for implementing autonomous control of said sea-surface vessel, wherein said autonomous mode of operation includes a remotely controlled mode of operation of said sea-surface vessel;
a first communications system for sending data and receiving data between an autonomous undersea vessel and said sea surface vessel;
a second control system for controlling said autonomous undersea vessel by using information transmitted from said first communications system, said information including a command for activation of at least one pre-programmed maneuver for said autonomous undersea vessel;
a navigation system on board said sea-surface vessel for locating said sea-surface vessel and providing said location information to said first control system;
a thrust system for controlling sea-surface vessel speed and direction according to control instructions from said first control system; and
a second communications system on board said sea-surface vessel for exchanging information with a remote management system, wherein said remote management system sends information for activating at least one autonomous pre-programmed maneuver of said sea-surface vessel and said remote management system receives information from said sea-surface vessel, including data from said autonomous undersea vessel.

2. The sea-surface vessel as described in claim 1 wherein said second control system is located on board said sea-surface vessel.

3. The sea-surface vessel as described in claim 1 wherein said second control system is located remotely from said sea-surface vessel.

4. The sea-surface vessel as described in claim 1 wherein said autonomous mode of said sea surface vessel includes using one or more of a plurality of pre-programmed maneuvers comprising direction of travel, speed, and duration of each maneuver.

5. The sea-surface vessel as described in claim 1 wherein said first communications system is an acoustic communications system.

6. The sea-surface vessel as described in claim 1 wherein said first communications system is configured for sending data to and receiving data from a plurality of autonomous undersea vessel.

7. The sea-surface vessel as described in claim 1 wherein said autonomous undersea vessel collects data from at least one undersea asset and sends said data to said sea-surface vessel via said first communications system.

8. The sea-surface vessel as described in claim 1 wherein said remote management system is located on a mother-ship vehicle that is physically separated from said sea-surface vessel.

9. A method for controlling an undersea activity using autonomous undersea vehicles, comprising:
providing a first autonomous sea-surface vehicle configured to operate according to at least one of a plurality of pre-programmed guidance maneuvers;
providing a first control system on said first autonomous sea-surface vehicle for activating a high precision steering and thrust system wherein steering and thrust control inputs are defined by at least one pre-programmed maneuver;
providing a wireless communications system on board said sea-surface vehicle for exchanging information with a remote management system, wherein said remote management system sends information for activating said at least one autonomous pre-programmed maneuver of said sea-surface vehicle;
providing a second control system for executing guidance and control commands for one or more undersea autonomous vehicles;
providing a communications link on board said first autonomous sea surface vehicle for communicating with one or more undersea autonomous vehicles to send an execution command to activate at least one of said pre-programmed maneuvers autonomously, and receiving task data acquired by said undersea autonomous vehicle.

10. The method of claim 9 further comprising:
receiving data acquired by said undersea autonomous vehicle that was generated by an under-sea asset.

11. The method of claim 9 wherein said at least one of said pre-programmed maneuvers is for interacting with an under-sea asset.

12. The method of claim 9 further comprising:
sending a plurality of execution commands to a plurality of undersea vehicles to activate a plurality of pre-programmed maneuvers that are executed simultaneously by said plurality of undersea vehicles.

13. The method of claim 9 further comprising:
dividing an undersea task into a plurality of sub-tasks wherein each of said subtasks are performed simultaneously by more than one of said undersea autonomous vehicles.

14. The method of claim 9 further comprising:
sending an execution command to one or more undersea vehicle to interact with an undersea asset.

15. A sea-surface vessel configured to operate in an autonomous mode and to direct autonomous operation of a plurality of undersea autonomous vehicles, said sea surface vessel comprising:
a first control system on board said sea-surface vessel for implementing autonomous control of said sea-surface vessel;
a first communications system for sending data and receiving data between said plurality of undersea autonomous vehicles and said sea surface vessel;
a second control system for controlling said plurality of undersea autonomous vehicles by using information transmitted from said communications system, said information including commands for activation of pre-programmed maneuvers for said plurality of undersea autonomous vehicles;
a navigation system on board said sea-surface vessel for locating said sea-surface vessel and providing said location information to said first control system;
a thrust system for controlling sea-surface vessel speed and direction according to control instructions from said first control system; and
a second communications system on board said sea-surface vessel for exchanging information with a remote management system, wherein said remote management system sends information for activating autonomous pre-programmed maneuvers of said sea-surface vehicle that are performed simultaneously and said remote management system receives information from said sea-surface vessel, including data from said plurality of undersea autonomous vehicles.

16. The sea-surface vessel as described in claim 15 wherein said second control system is located on board said sea-surface vessel.

17. The sea-surface vessel as described in claim 15 wherein said second control system is located remotely from said sea-surface vessel.

18. The sea-surface vessel as described in claim 15 wherein said first communications system is configured for sending data to and receiving data from said plurality of undersea autonomous vehicles simultaneously.

19. The sea-surface vessel as described in claim 15 wherein said plurality of undersea autonomous vehicles collect data from at least one sensor and sends said data to said sea-surface vessel via said first communications system.

20. The sea-surface vessel as described in claim 15 wherein said remote management system receives data in real-time from one or more of said plurality of undersea autonomous vehicles.
